(19) United States
(12) Patent Application Publication
(10) Pub. No.: US 2014/0250659 A1
(43) Pub. Date: Sep. 11, 2014

(54) ARTICLE ASSEMBLY METHOD EMPLOYING ROTARY ARTICLE PICK AND PLACE

(71) Applicant: COSMETIC LABORATORIES OF AMERICA, LLC, Waukegan, IL (US)

(72) Inventor: Scott Andrew MacDougall, Ventura, CA (US)

(73) Assignee: Cosmetic Laboratories of America, LLC, Waukegan, IL (US)

(21) Appl. No.: 13/787,974

(22) Filed: Mar. 7, 2013

(51) Int. Cl. B23P 11/00

(52) U.S. Cl. CPC B23P 11/00
USPC 29/428

(57) ABSTRACT

An article assembly apparatus and method employs rotary pick and place technology to deposit one component of an apparatus within another at a relatively high rate of speed. A substantially disk-shaped component is inserted within a substantially cylindrical component with a relatively tight fit between the two. The substantially disk-shaped component is carried at a fixed, predetermined angle, relative to a radius of a rotating wheel carrying the component, permitting the smooth placement and depositing of the substantially cylindrical component within the substantially cylindrical component. The substantially disk-shaped component may comprise a piston and the substantially cylindrical component may comprise a body of a bottom filled airless container undergoing assembly following the placement of a substance to be dispensed within the body.

### BACKGROUND OF THE INVENTION

1. Field of the Invention

The present invention relates, in general, to article assembly apparatuses and methods, and, more particularly, to apparatuses and methods for the insertion of round discs into open ended cylinders at a high rate of speed.

2. General Background of the Invention

Article assembly apparatuses are known. One type of article assembly apparatuses employs rotary pick and place technology to pick up, transfer, and place an article from one location to another. Pick and place technology may be employed, for example, to deposit an article upon a moving linear transport.

To accomplish this, rotary pick and place devices may be employed. One such prior art rotary pick and place device is disclosed in U.S. Pat. No. 4,901,843 to Lashyro. Such rotary pick and place devices are commonly relatively complex in design and operation, involving motorize mechanisms having multiple axes of rotation in order to smoothly deposit an article upon a moving linear transport.

Accordingly, it is an object of the present invention to provide an article assembly device and method that is capable of depositing one component of an apparatus within another at a relatively high rate of speed.

It is another object of the present invention to provide an article assembly device and method capable of inserting a substantially disk-like component within a substantially cylindrical component, wherein there is a relatively tight fitting, with narrow clearance, of the substantially disk-shaped (i.e., relatively squat and cylindrical) component within a substantially cylindrical component.

It is yet another object of the present invention to provide an article assembly device and method for assembling at least a portion of a bottom-filled airless pump-type dispensing container, by inserting a disk-like piston into a substantially cylindrical body of the container through a circular bottom opening of the container.

These and other objects and features of the present invention will become apparent in view of the following specification, drawings and claims.

### BRIEF SUMMARY OF THE INVENTION

The present invention comprises an apparatus and method for high speed assembly of an article and employing rotary pick and place technology. In one embodiment of the invention, the article to be assembled comprises a bottom-filled airless pump-type container, having a substantially cylindrical outer body and a substantially disk-like piston. Each of the plurality of containers to be assembled is inserted, bottom opening facing up, into an associated carrier for linear conveyance along an assembly line. As each container and associated carrier reaches the present assembly apparatus, it is gripped by two opposing pairs of counter-rotating star wheels, also known as indexing wheels. In particular, one pair of opposing counter-rotating star wheels grips the carrier, and, simultaneously, the other pair of opposing counter-rotating star wheels grips the cylindrical container.

In timed coordination with the linear movement of the conveyor and the horizontal rotation of the star wheels, a vertically orientated and rotating vacuum wheel, also known as an indexing wheel, sequentially retrieves and releasably grips substantially disk-like bottom pistons from a supply chute, carries the piston for a portion of a complete rotation of the vacuum wheel, and then releases and inserts each piston through a circular opening of the substantially cylindrical outer body of the airless container. In one embodiment of the invention, the vacuum wheel includes ten vacuum stems, spaced on equidistantly spaced radii extending from a center of the vacuum wheel and radiating outwardly from a circumferential outer surface of the vacuum wheel.

A vacuum manifold receives a supply of external vacuum and applies the vacuum to each vacuum stem during only a predetermined segment of the overall 360° rotation of each vacuum stem. This, in turn, causes vacuum to be applied to a distal gripping surface of a collar of each vacuum stem, beginning immediately prior to each empty vacuum stem coming into proximity with the piston dispensing chute, and ending upon the placement of the piston through the circular bottom opening of the airless container cylindrical body and into the interior of the container body. As the vacuum stem completes a rotation together with the remainder of the vacuum wheel, it is ready to repeat the foregoing cycle with another piston disposed at a pick-off location of the piston supply chute.

To impart coordinated, timed rotational movement of both the pairs of star wheels and the vacuum wheel, a main drive motor turns an associated motor output pulley to, in turn, move a timing drive belt coupled to the motor output pulley. The timing drive belt, in turn, causes the opposite rotation of two star wheel timing pulleys, each coupled to an associated star wheel shaft. A shaft coupling is employed to couple one of the star wheel shafts to a gearbox drive shaft while, at the same time, permitting vertical height adjustment of the gearbox and vacuum wheel. The gearbox transfers rotation from the gearbox driveshaft to the vacuum wheel drive shaft to, in turn, impart rotation of the vacuum wheel. The gearbox may employ fixed or adjustable gear ratios to, in turn, impart a desired rotational speed of the vacuum wheel, relative to a desired rotational speed of the star wheels. In one embodiment of the invention, the gearbox has a fixed, 1:1 input to output ratio.

Unlike prior art rotary pick and place apparatuses and methods that employ relatively complex mechanisms that involve the rotation of the retrieved article about multiple axes of rotation, the present apparatus is able to accomplish the high speed insertion of a substantially disk-shaped component through a closely fitting aperture of a cylindrical body, only slightly larger in diameter than that of the disk-shaped component, while carrying the disk-shaped component through only a single axis of rotation. In particular, it has also been discovered by the inventor that, by disposing the disk-shaped component at a particular angle, relative to radii of the vacuum wheel, only a single axis of rotation is necessary in order to smoothly deposit the disk-shaped component through the tightly-fitting aperture and into the cylindrical body. Specifically, the inventor has also discovered that a specific angle relative to the radii emanating from the center of the vacuum wheel, denoted as θ (theta), of between 20° and 30°, works optimally in this regard.

In an apparatus and in a method of the present invention, a component transfer mechanism is provided for inserting a first component, such as a substantially disk-shaped piston of a bottom-filled airless pump-type dispensing container, within a second component, such as a substantially cylindrical body of a bottom-filled airless pump-type dispensing container, having a circular bottom aperture and in motion along a horizontal axis. A least one first component gripping member, which may comprise a vacuum stem coupled to a vacuum wheel, is provided and is supported above the horizontal axis by a frame or other support for rotation in a substantially circular path about a center point. The at least one first component gripping member is disposed along a radius extending from the center point and in a plane of rotation of the at least one first component gripping member. The at least one first component gripping member grasps and holds the first component beginning at a first position along the substantially circular path and at a predetermined, fixed angled offset relative to the radius, and carries the at least one first component gripping member carrying the first component through a portion of a complete rotation of the first component gripping member about the center point. The at least one first component gripping member places at least a portion of the first component through an aperture of the second component and within at least a portion of an interior region of the second component when the at least one first component gripping member is at a second position along the substantially circular path. The at least one first component gripping member releases its hold on the first component after placing at least a portion of the first component within at least a portion of the second component when the at least one first component gripping member is at a third position along the substantially circular path, thereby inserting at least a portion of the first component within the second component.

In an embodiment of the present invention, the at least one first component gripping member holds the first component at a fixed angle of about 20 degrees to about 30 degrees relative to the radius emanating from the center point of the vacuum wheel. During assembly, the at least one first component gripping member places a leading edge of the first component through the aperture of the second component and within at least a portion of the interior region of the second component at an oblique angle, relative to the aperture, when the at least one first component gripping member is at the second position along the substantially circular path.

The at least one first component gripping member further comprises a channel extending through at least a portion of the at least first component gripping member and coupled to a periodic source of vacuum pressure. The at least one first component gripping member holds the first component when vacuum pressure is applied to the channel and releases the first component when vacuum pressure is removed from the channel.

In an embodiment of the invention, the at least one first component gripping members comprises a plurality of first component gripping members, such as ten first component gripping members, with each of the first component gripping members being disposed about a circumference of a wheel, such as a vacuum wheel, rotating about the center point.

The wheel may include a stationary vacuum manifold and a rotating hub adjacent the vacuum manifold. The channel extending through at least a portion of the least one first component gripping member is coupled to the rotating hub, causing the vacuum manifold to supply vacuum pressure to the rotating hub and the channel through only a portion of a complete rotation of the first component gripping member about the center point.

A motorized drive mechanism is provided to impart rotational movement of the at least one first component gripping manner in synchronization with the motion of the second component along the horizontal axis. A chute is provided to supply a plurality of first components for sequential picking up and holding by the at least one first component gripping member.

The center point and, in turn, the wheel and at least one first component gripping member, all may be supported above the horizontal axis along which the second component moves in a height adjustable manner, thereby accommodating second components of varying dimensions.

### BRIEF DESCRIPTION OF THE SEVERAL VIEWS OF THE DRAWINGS

FIG. 1 is an elevated side sectional view of an airless container apparatus capable of partial assembly via the apparatus and method of the present invention;

FIG. 2 is an elevated side sectional view of the airless container apparatus of FIG. 1, shown upside down and with the piston and bottom plate in position for assembly;

FIG. 3 is an elevated left side view of the present assembly apparatus;

FIG. 4 is an elevated front view of a portion of the present assembly apparatus;

FIG. 5 is an elevated rear perspective view of a portion of the present assembly apparatus, with the star wheels, conveyor, and shaft coupling, among other components, being removed for clarity;

FIG. 6 is an elevated perspective view of the piston supply chute of the present assembly apparatus;

FIG. 7 is a simplified schematic diagram of the primary power and drive train components of the present assembly apparatus;

FIG. 8 is a simplified schematic diagram of the operation of the timing belt and associated pulleys and idlers of the drive train of the present assembly apparatus;

FIG. 9 is an exploded elevated side sectional view of a vacuum stem of the present assembly apparatus; and

FIG. 10 is a simplified elevated side view of the operation of the vacuum wheel, showing, in particular, the selective application of vacuum to the vacuum stems and the positioning of the vacuum stems relative to the bottom aperture of the cylindrical body of the airless containers undergoing assembly.

### DETAILED DESCRIPTION OF THE INVENTION

While the present invention is susceptible of embodiment in many different forms, there is shown in the drawings and will herein be described in detail, one specific embodiment, with the understanding that the present disclosure is intended as an exemplification of the principles of the present invention and is not intended to limit the invention to the embodiment illustrated.

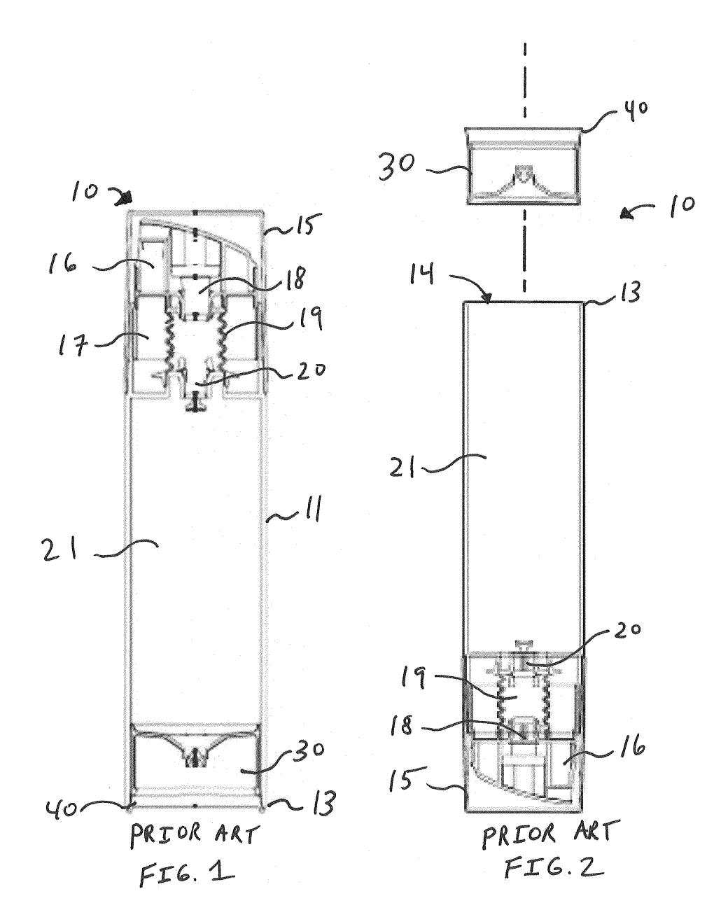

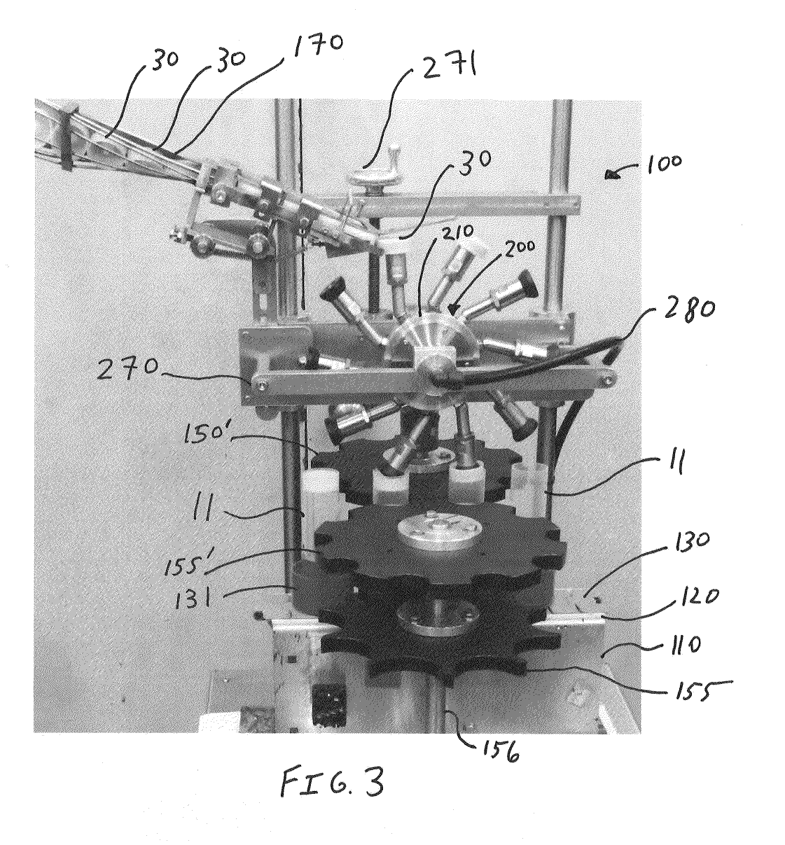

A prior art bottom-fill airless container 10, such as the MEGA® container manufactured by MegaPlast GmbH, is shown in FIGS. 1 and 2 as comprising cylindrical body 11 having top end 12, bottom end 13, and circular bottom aperture 14 opening into the interior of body 11. Operably coupled to body 11 are actuator top 16, actuator collar 18, upper valve 18, bellows 19, and lower valve 20. A reservoir region 21 for fluids, such as lotions or creams for cosmetic application, for example, is disposed within body 11 between lower valve 20 and piston 30. End cap 40 secures piston 30 in place within body 11 adjacent bottom aperture 14. Top cap 15 provides a protective cover about actuator top 16. As shown in FIG. 2, a predetermined volume of a desired fluid is poured into reservoir region 21, and then piston 30 is placed through bottom aperture 14 and body 11 is sealed by end cap 40.

Airless container assembly apparatus 10 is shown in FIGS. 3-10 as comprising support frame 110, top plate 120, conveyor 130, main drive motor 140, first star wheels 150 and 150′, second star wheels 155 and 155′, shaft coupling 160, gear box 170, piston supply chute 180, vacuum wheel 200 comprising vacuum stem hub 210 supporting ten vacuum stems 220, vacuum wheel support 270, and vacuum supply hose 280.

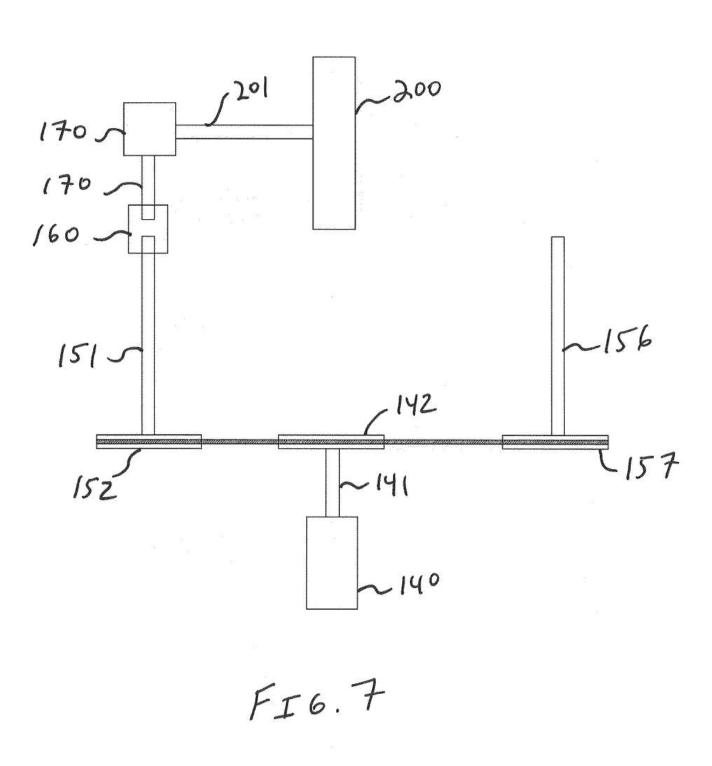

As best seen in FIG. 6, piston supply chute 180 provides a steady supply of pistons 30 as needed for airless container assembly through a rotating, caged track and via a gravity feed. A proximal end of piston supply chute 180 includes pickoff singulator 181, having top gripping member 182 and side gripping member 183, continually placing the next piston 30 into position for retrieval by an associated collar 260 of a vacuum stem 220.

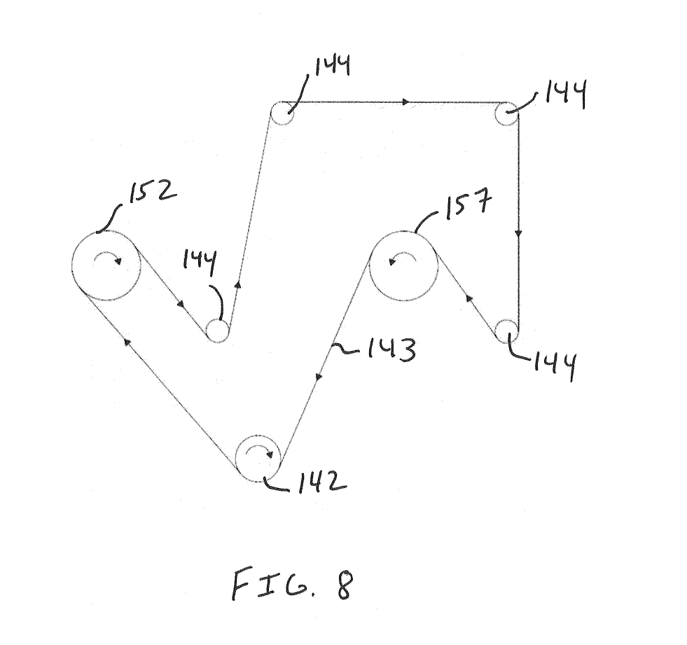

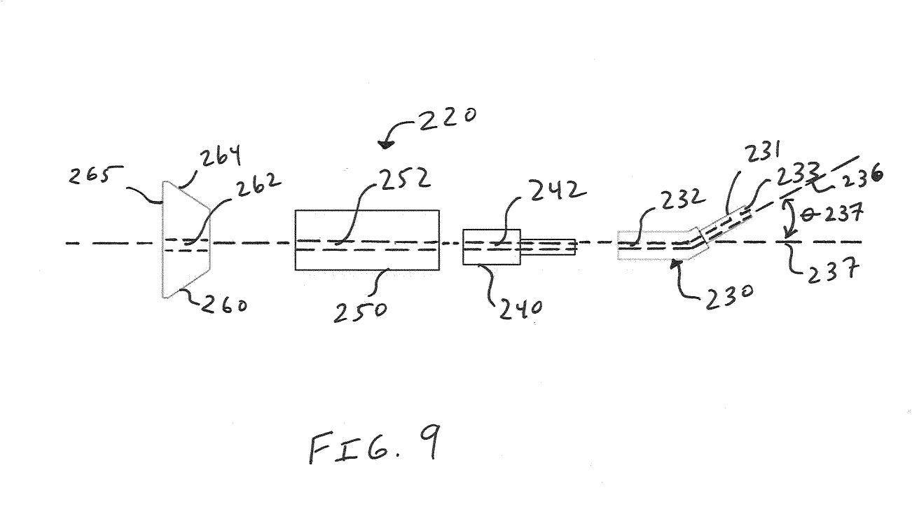

Referring to FIGS. 7 and 8, main drive motor 140, supplying motive energy throughout article container apparatus 10, may comprise an alternating current electric motor, rated at ½ horsepower and operating at 1,750 rotations per minute. In an embodiment of the invention, main drive motor 140 has an internal 40:1 gear reduction ratio ahead of motor output shaft 141, which is coupled to motor pulley 142. Moreover, main drive motor 140 preferably includes, or is coupled to, a variable frequency drive controller, permitting adjustment to the rotational speed of motor output shaft 141 and, in turn, the rotational speeds of first star wheels 150 and 150′, second star wheels 155 and 155′, and vacuum wheel 200.

Motor pulley 142, in turn, drives continuous timing drive belt 143, which may be constructed of neoprene or another strong yet sufficiently resilient material. Timing drive belt 143, is operably coupled to and imparts rotational movement to first star wheel timing pulley 152 in a clockwise direction, as viewed from above, and to second star wheel timing pulley 157 in a counterclockwise direction, as viewed from above. Four idler wheels 144, at least one of which is preferably adjustable in position, provide tension on timing drive belt 143, and ensures that an adequate length of timing drive belt 143 engages sufficient corresponding amounts of arc length of both first star wheel timing pulley 152 and second star wheel timing pulley 158 in order to smoothly rotate both pulleys.

The rotation of first star wheel timing pulley 152 imparts rotation to first star wheel shaft 151, operably coupled to first star wheel timing pulley 152. As both star wheels 150 and 150′ are secured to first star wheel shaft 151 in a vertically spaced relation to each other, clockwise rotation of first star wheels 150 and 150′ are imparted by the rotation of first star wheel shaft 151. Likewise, the rotation of second star wheel timing pulley 158 imparts rotation to second star wheel shaft 156. As both star wheels 155 and 155′ are secured to second star wheel shaft 156, counterclockwise rotation of second star wheels 155 and 155′ are imparted by the rotation of second star wheel shaft 156.

First star wheel shaft is further coaxially coupled to gear box drive shaft 171 via shaft coupling 160. The use of shaft coupling 160 permits the vertical height of gearbox 170 and vacuum wheel to be adjusted to a desired height, in order to accommodate varying lengths of airless containers that are under assembly. Vertically oriented gear box drive shaft 171 drives gear box 170 which, in turn, drives horizontally oriented vacuum wheel drive shaft 171. As vacuum wheel 200 is secured to vacuum wheel drive shaft 171, corresponding rotation movement is accordingly imparted to vacuum wheel 200. In an embodiment of the present invention, gear box 170 has a 1:1 gear ratio. Other ratios may alternatively be employed to impart different rates of rotation to vacuum wheel 200.

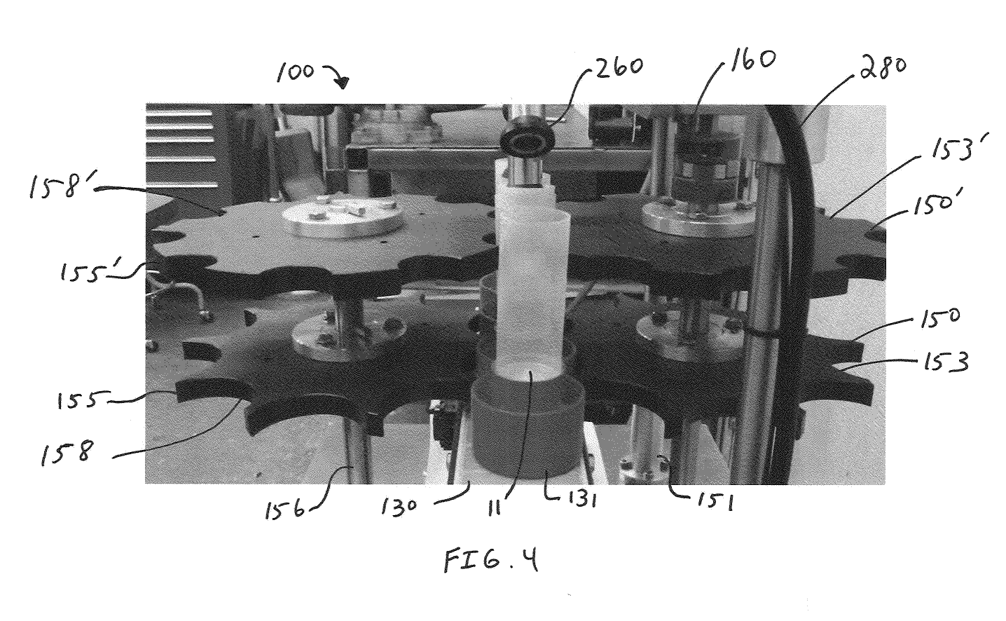

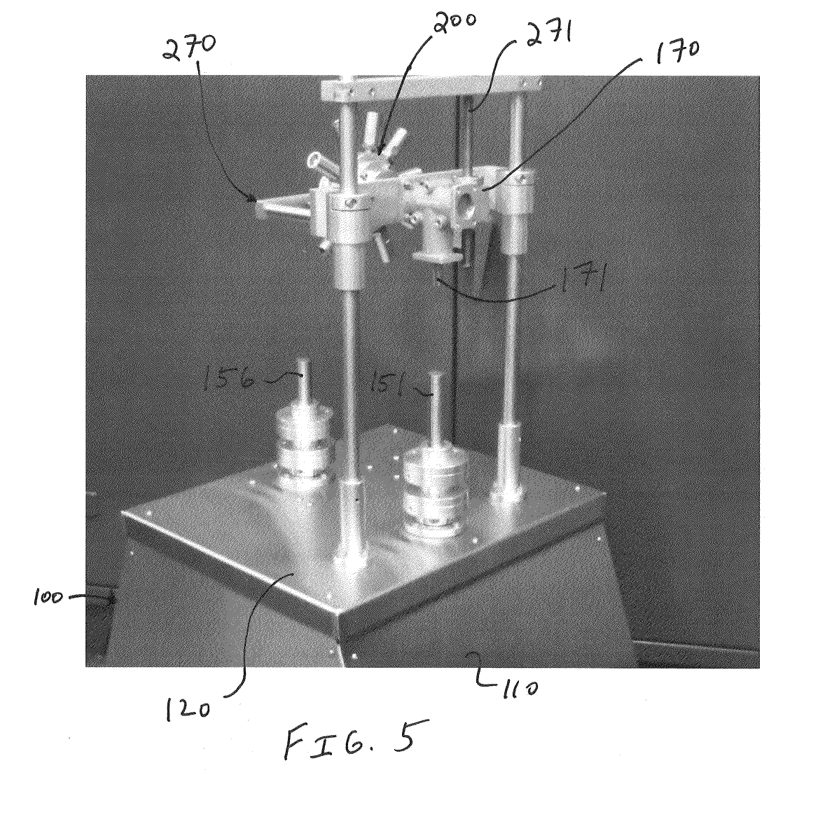

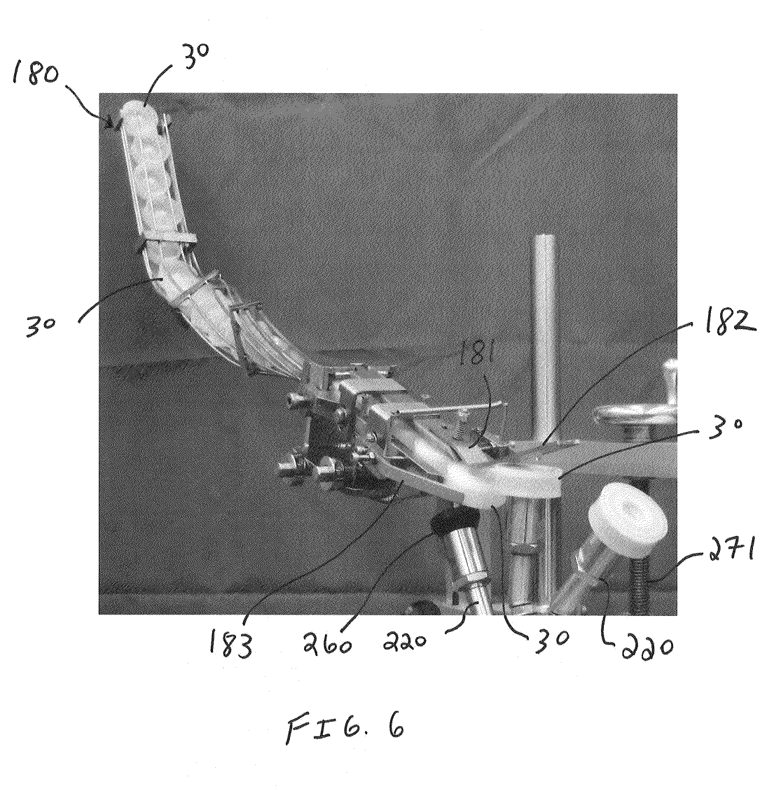

Main drive motor 140, motor output shaft 141, motor pulley 142, timing drive belt 143, first star wheel timing pulley 152, second star wheel timing pulley 157, and idler wheels 144 are all housed within an interior region of support frame 100, shown in FIG. 5. Top plate 110 of support frame provides a supporting surface for conveyor 130 of FIG. 4, for example. First star wheel shaft 151 and second star wheel shaft 156 extend from the interior of support frame 100, through corresponding apertures through top plate 110. Vacuum wheel support 270 carries both vacuum wheel 200 and gearbox 170, and slidaby engages two parallel rods extending vertically from top plate 110. Threaded height adjuster 271 may be manually turned in order to raise or lower vacuum wheel support relative to top plate 110 to, in turn, raise and lower vacuum wheel 200 and gear box 170, enabling Airless container assembly apparatus 10 to accommodate articles under assembly of varying overall height.

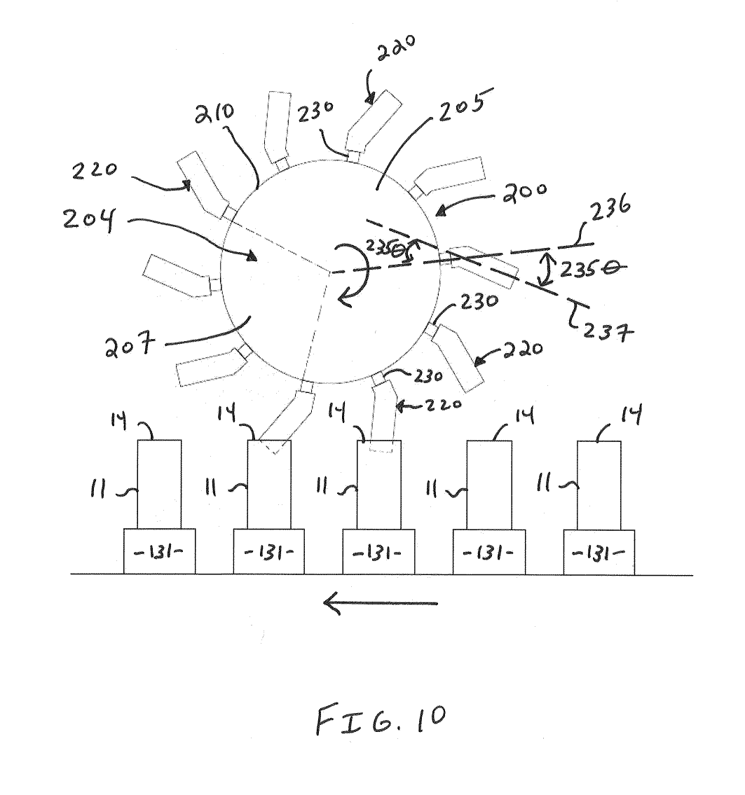

Referring to FIG. 9, the various components of one vacuum stem 220 are shown as comprising angled shaft 230, inner shaft 240, outer shaft 250, and collar 260. Collar 260 has tapered sides 264 and comprises central channel 262, communicating between inlet port 263 disposed through outer face 265 and an outlet port disposed through an opposing side of collar 260, permitting the transmission of vacuum pressure through central channel 260. During operation of bottom fill airless container apparatus 10, outer face 265 mates flush with a bottom surface of a piston 30, with vacuum pressure being transmitted through central channel 262 to inlet port 263 to secure piston 30 to collar 260 for so long as vacuum pressure remains applied to vacuum stem 260.

Collar 260 is coupled to outer shaft 250, with central channel 262 of collar 260 in axial alignment and communication with central channel 252 of outer shaft 250. Outer shaft 250 is likewise coupled to inner shaft 240, with central channel 252 of outer shaft 250 in axial alignment and communication with central channel 242 of inner shaft 240. Moreover, inner shaft 240 is similarly coupled to angled shaft 230, with central channel 242 of inner shaft 240 in axial alignment and communication with central channel 232 of angled shaft 230.

Angled shaft 230 includes vacuum stem attachment region having outlet port 233 extending through a proximal end of angled shaft 230, and is coupled to a corresponding port of vacuum stem hub 210 of vacuum wheel 200. In this manner vacuum pressure is communicated along the entire interior of vacuum stem 220, with air flowing from inlet port 263 of collar 260 to outlet port 233 of angles shaft 230.

As shown in FIG. 9, a distal portion of angled shaft 230 has a primary longitudinal axis 237 that is aligned with the overall primary longitudinal axis of vacuum stem 220, further extending through inner shaft 240, outer shaft 250 and collar 260. However, proximal vacuum stem attachment region 231 has a second axis 236 that is fixed at a predetermined angle θ 235 relative to longitudinal axis 237. In a preferred embodiment, this angle is between 20° and 30°, which has been found by the inventor to work optimally for the insertion of piston 30 into cylindrical body 11 of bottom fill airless container 10.

Referring to FIGS. 3 and 4, conveyor 130 carries a succession of airless container assembly carriers 131 through a central region of airless container assembly apparatus 100. Carriers 131 do not form any portion of overall bottom fill airless container 10, but rather serve to firmly secure an associated airless container 10 in an upright orientation as they undergo filling and final assembly. As best seen in FIG. 4, star wheels 150 and 155 are identical to each other in construction, each containing ten arcuate indentations 153, 158, sized to cooperatively surround a substantial portion of the outer circumference of each carrier 131 carried along conveyor 130. Star wheels 150′ and 155′ are likewise identical to each other in construction, each containing ten arcuate indentations 153′, 158′, smaller than indentations 153 and 158, sized to cooperatively surround a substantial portion of the outer surface of cylindrical body 11 of airless container 10.

In this manner, each airless container 10 undergoing assembly is carried along conveyor 130 at a predetermined position, due to the coordinated rotation of star wheels 150, 150′, 155, 155 and vacuum wheel 200, permitting each vacuum stem 220 to repeatedly retrieve a piston 30 from chute 180 using suction created via the application of vacuum pressure at inlet port 263, carry piston 30 through only a portion of a complete rotation of vacuum wheel 200, and deposit piston 30 through a cylindrical bottom aperture 14 of cylindrical body 11 of airless container 10 before vacuum pressure is removed from vacuum stem 220. Each airless container 10 moves along conveyor 130 being positioned by the star wheels so as to be appropriately located as an associated vacuum stem approaches, and as a distal portion of collar 260 of an associated vacuum stem 220 then passes through bottom aperture 14 of cylindrical body 11, depositing a carried piston 30 in place within cylindrical body 11 immediately prior to the removal of vacuum pressure to vacuum stem 220, releasing piston 30 thereby permitting piston 30 to be retained in place within cylindrical body 11 as the distal portion of collar 260 then exits the interior of cylindrical body 11 and completes its rotation, ready to retrieve another piston 30 from chute 180 as vacuum is again applied to vacuum stem 220.

As illustrated in FIG. 10, vacuum wheel 200 includes a stationary manifold 204, which receives vacuum pressure via a central vacuum bore coupled to vacuum supply hose 280 of FIG. 3, for example. Vacuum manifold 204 includes vacuum active region 205, comprising, in an embodiment of the present invention, approximately 250° of rotation of vacuum wheel 200, and vacuum inactive region 207, comprising, in an embodiment of the present invention, approximately 110° of rotation of vacuum wheel 200. Ten vacuum stems 220 are coupled to vacuum stem hub 210, each with a radius extending from the center of vacuum wheel 200 evenly spaced 36° apart from the adjacent radii of both the immediately preceding vacuum stem 220 and the immediately following vacuum stem 220. Angled shaft 231 of each vacuum stem 220 is coupled to an associated port through an outer surface of vacuum stem hub 210, with the central channel extending though vacuum stem 220 in communication with the interior of vacuum stem hub 210.

Accordingly, as shown in FIG. 10, as vacuum stem hub 210 rotates relative to adjacent vacuum manifold 204, each vacuum stem 220 repeatedly travels with and transitions between vacuum active region 205 and vacuum inactive region 207. Upon reaching the beginning of vacuum active region 205, each vacuum stem 220 is in close proximity to piston supply chute 180, where vacuum stem 220 picks up and holds adjacent a piston 30. Further along vacuum active region 205, a distal portion of each vacuum stem 220, and, in turn, a piston 30 carried by vacuum stem 220, passes through circular bottom aperture 14 of cylindrical body 11 of bottom fill airless container 10, into the interior of cylindrical body 11. Initially, each piston 30 enters a corresponding cylindrical body at angle, with a leading edge of piston 30 at a lower height than a trailing edge of piston 30. As a distal end of each vacuum stem 220 reaches its lowest point, relative to top plate 110, piston 30 is in a substantially horizontal orientation, and is substantially parallel to top plate 110. Shortly afterwards, vacuum stem 220 reaches the transition point from vacuum active region 205 to vacuum inactive region 207, and piston 30 is released within the interior of cylindrical body 11. Next, as vacuum stem 220 continues its rotation, its distal end exits cylindrical body 11 through circular bottom aperture 14. As best seen in FIG. 10, the carriage of each piston 30 by an associated vacuum stem 220 at a fixed angle of θ 235, relative to a radii emanating from the center of vacuum wheel 200, as opposed to holding each piston perpendicular to the radii (i.e., with no angle, or an angle of zero degrees), permits the leading edge of each piston to obliquely enter an associated cylindrical body 11, and then rotate to a level orientation as cylindrical body proceeds in a linear manner, and as piston 30 simultaneously proceeds in an arcuate manner. As a result, airless container assembly apparatus 100 is capable of inserting pistons 30 within cylindrical bodies 11 at a high rate of speed, and with each piston being carried about only a single axis of rotation.

Many modifications and variations of the present invention are possible in light of the above teachings. It is therefore to be understood that within the scope of the appended claims, the invention may be practiced other than as specifically described. Various modifications, changes and variations may be made in the arrangement, operation and details of construction of the invention disclosed herein without departing from the spirit and scope of the invention. The present disclosure is intended to exemplify and not limit the invention.

What is claimed is:

1. A method for inserting a first component within a second component, the second component being in motion along a horizontal axis, the method comprising:
grasping the first component beginning at a first position along a substantially circular path, the substantially circular path being about a center point and in a plane of rotation above the horizontal axis of motion of the second component, the first position being disposed along a radius extending from the center point and in the plane of rotation of the at least one first component gripping member;
holding the first component at a predetermined, fixed angled offset relative to the radius;
carrying the first component through a portion of a complete rotation about the center point and along the circular path;
placing at least a portion of the first component through an aperture of the second component and within at least a portion of an interior region of the second component at a second position along the substantially circular path, and
releasing the first component after placing at least a portion of the first component within at least a portion of the second component when the first component is at a third position along the substantially circular path, thereby inserting at least a portion of the first component within the second component.

2. The method according to claim 1, wherein the predetermined, fixed angled offset relative to the radius is about 20 degrees to about 30 degrees.

3. The method according to claim 1, further comprises the step of applying vacuum pressure to the first component to hold the first component in place and at the predetermined, fixed angled offset about a portion of a complete rotation about the substantially circular path.

4. The method according to claim 1, further comprising providing a plurality of first component gripping members, each of the first component gripping members being disposed about a circumference of a wheel rotating about the center point, each of the first component gripping members being capable of separately gripping a first component about a portion of a complete rotation about the substantially circular path.

5. The method according to claim 4, wherein the plurality of first component gripping members comprises ten component gripping members.

6. The method according to claim 4, wherein vacuum pressure is supplied to each of the plurality of first component gripping members during only a portion of a complete rotation about the substantially circular path, the first component being gripped by an associated first component gripping member only when vacuum pressure is supplied to the associated first component gripping member.

7. The method according to claim 1, wherein rotational movement of the at least one first component gripping manner is synchronized with the motion of the second component along the horizontal axis.

8. The method according to claim 1, wherein a plurality of first components are sequenced and supplied for sequential picking up and grasping by the at least one first component gripping member.

9. The method according to claim 1, wherein the first component is substantially disk-shaped and the second component is substantially cylindrical in shape and has a substantially circular opening at at least one end of the second component.

10. The method according to claim 1, wherein the first component comprises a piston of a bottom-filled airless pump-type dispensing container and the second component comprises a cylindrical body of a bottom-filled airless pump-type dispensing container.

11. The method according to claim 1, wherein the center point is adjustable in height relative to the horizontal axis.

12. The method according to claim 1, wherein a leading edge of the first component is placed through the aperture of the second component and within at least a portion of the interior region of the second component at an oblique angle, relative to the aperture, when the first component is at the second position along the substantially circular path.
